(19) United States
(12) Patent Application Publication
(10) Pub. No.: US 2026/0332784 A1
(43) Pub. Date: Oct. 22, 2026

(54) REFERENCE FRAME FLAG SIGNALING

(71) Applicant: GOOGLE LLC, Mountain View, CA (US)

(72) Inventors: Cheng Chen, Milpitas, CA (US); Lester Lu, Los Angeles, CA (US); Debargha Mukherjee, Cupertino, CA (US); Jingning Han, Santa Clara, CA (US)

(21) Appl. No.: 19/484,407

(22) PCT Filed: Apr. 19, 2024
(86) PCT No.: PCT/US2024/025428

§ 371 Date: Nov. 14, 2025

Related U.S. Application Data
(60) Provisional application No. 63/466,365, filed on May 15, 2023.

(51) Int. Cl. H04N 19/172; H04N 19/105; H04N 19/44; H04N 19/46

(52) U.S. Cl. CPC H04N 19/172; H04N 19/105; H04N 19/44; H04N 19/46

(57) ABSTRACT

An integer value indicative of a slot of a reference frame buffer to be updated is decoded from a compressed bitstream. A first frame is decoded. The decoded first frame is added to the slot indicated by the integer value. The decoded first frame is used, from the reference frame buffer, as a reference frame for decoding a second frame.

### CROSS REFERENCE TO RELATED APPLICATIONS

This application claims priority to and the benefit of U.S. Provisional Patent Application Ser. No. 63/466,365, filed May 15, 2023, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to signaling of the refresh frame flag(s).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method. The method includes decoding, from a compressed bitstream, an integer value indicative of a slot of a reference frame buffer to be updated. The method also includes decoding a first frame. The method also includes adding the decoded first frame to the slot indicated by the integer value. The method also includes using the decoded first frame, from the reference frame buffer, as a reference frame for decoding a second frame. Other embodiments of this aspect include corresponding computer systems, apparatus, and computer programs recorded on one or more computer storage devices, each configured to perform the actions of the methods.

Implementations may include one or more of the following features.

The method may include decoding, from the compressed bitstream, another integer value indicative of either refreshing a predetermined slot of the reference frame buffer or refreshing no slot of the reference frame buffer; and decoding, from the compressed bitstream, a flag indicating whether to refresh the predetermined slot of the reference frame buffer or to refresh no slots of the reference frame buffer.

The method may include determining that the flag indicates to refresh the predetermined slot; and in response to the flag indicating to refresh the predetermined slot, adding a decoded second frame to the predetermined slot.

The reference frame buffer may include N slots, and the integer value can be represented by ceiling(log₂(N)) number bits, where ceiling( ) is a function that rounds up to a nearest integer.

The integer value may be decoded from a header of the first frame.

The method may include decoding, from the compressed bitstream, a frame type of a third frame, where the frame type indicates that all slots of the reference frame buffer are to be refreshed; and determining to refresh all slots of the frame buffer based on the frame type.

The method may include decoding, from the compressed bitstream, a flag indicating that no slots of the reference frame buffer are to be updated after a fourth frame is decoded; decoding the fourth frame; and omitting updating the reference frame buffer subsequent to decoding the fourth frame.

Implementations of the described techniques may include hardware, a method or process, or computer software on a computer-accessible medium.

Another general aspect is a method that includes determining that a group of pictures is to be decoded using a multi-level coding structure. The method also includes decoding, from a frame header of a current frame of the group of pictures, a pyramid level indicative of a level within the multi-level coding structure. The method also includes decoding the current frame. The method also includes updating a reference frame buffer based on the pyramid level. Other embodiments of this aspect include corresponding computer systems, apparatus, and computer programs recorded on one or more computer storage devices, each configured to perform the actions of the methods.

Implementations may include one or more of the following features.

The pyramid level may be decoded as a three-bit integer number.

The method may include decoding a flag indicating that the reference frame buffer is to be updated based on the pyramid level.

Another aspect is a non-transitory computer-readable storage medium having stored thereon a compressed bitstream that is configured for decoding by operations that perform the operations of any of the preceding aspects.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a block diagram of an example of a reference frame buffer.

FIG. 7 is an illustration of conventional signaling and a technique for updating a reference frame buffer.

FIG. 8 is an illustration of reference frame flag signaling according to the n-bit integer technique.

FIG. 9 is a diagram of an example of a multi-layer coding structure.

FIG. 10 is a flowchart diagram of a technique for updating a reference frame buffer.

FIG. 11 is a flowchart diagram of another technique for updating a reference frame buffer.

### DETAILED DESCRIPTION

Video compression schemes may include breaking respective images, or video frames, into smaller portions, such as video blocks, and generating an encoded bitstream using techniques to limit the information included for respective video blocks thereof. The encoded bitstream can be decoded to re-create the source images from the limited information. Encoding or decoding a video block can include predicting motion within that video block, such as with respect to one or more other video blocks in the same video frame or in a different video frame. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities can be known as inter prediction. Inter prediction attempts to predict the pixel values of a block using a possibly displaced block or blocks from one or more temporally nearby frames (i.e., reference frames). A temporally nearby frame is a frame that appears earlier or later in time in the video stream than the frame of the block being encoded. A prediction block resulting from inter prediction is referred to herein as inter predictor. Reference frames can be stored in a reference frame buffer. In an example, the reference frame buffer may include N (e.g., N=8) number of slots. As such, N maximum reference frames can be stored in the reference frame buffer.

The reference frame buffer update process is a dynamic mechanism crucial for maintaining encoding efficiency and video quality. During the course of video compression, an encoder frequently updates the reference frame buffer by adding newly decoded frames, replacing existing frames, or invalidating slots as needed. This updating is guided by signals sent from the encoder to the decoder, specifying which slots of the frame buffer the decoder should invalidate or overwrite. These signals are based on an evaluation by the encoder of reference frame relevance and anticipated future utility. The encoder determines which reference frames to replace or invalidate by analyzing factors such as frame similarity, scene changes, motion complexity, buffer occupancy, and/or other factors. As such, the most useful frames for predicting future frames can be maintained in the reference frame buffer, thereby optimizing both the compression efficiency and the visual quality of the video stream.

To illustrate, after a frame is decoded, the reference frame buffer may be updated. For example, the decoded frame can be added to the reference frame buffer in an empty (or available) slot, the frame may replace another reference frame in the reference frame buffer, and/or other reference frames may be removed from (e.g., overwritten in) the reference frame buffer. If added to the reference frame buffer, the decoded frame can be used as a reference frame for subsequently decoded frames.

Conventionally, the reference frame buffer is updated according to a bitmap (or bitmask). The bitmap, which may be referred to as refresh frame flags, is included in the frame header of the frame to be decoded. As is known, a frame header is an uncompressed section of data in a compressed bitstream at the beginning of a video frame that provides information that can be used for decoding the video frame. Conventionally, the bitmap includes a bit for each slot in the reference frame buffer. As such, N bits may traditionally be used per frame to convey the refresh frame flags, which is a significant number of bits. Using N bits (flags) in frame headers corresponding to each of the slots of the reference frame buffer can consume a significant number of bits in a compressed bitstream.

Implementations according to this disclosure reduce the number of bits required to indicate which slots of a reference frame buffer are to be updated. For example, the number of bits used to signal which slots of the frame buffer are to be refreshed can be reduced from 8 (in the case that 8 reference frames are stored in the reference frame buffer) to 3.125 bits, as further described herein, by changing the way that the refresh frame flags are signaled (e.g., encoded in a compressed bitstream and decoded from the compressed bitstream) as compared to the conventional technique (e.g., signaling using a bitmap). Two general techniques are disclosed herein, which use less than 8 bits for signaling the refresh frame flag(s).

A first technique, referred to herein as the n-bit integer technique, generally uses an integer variable, instead of flag(s), to signal which of the slots of the reference frame buffer are to be updated. According to the n-bit integer technique, an integer value indicative of a slot of a reference frame buffer to be updated is decoded from a frame header of a frame. The frame is decoded. The decoded frame is added to the slot of the reference frame buffer indicated by the integer value. The decoded frame can then be used (e.g., is available for use) as a reference frame for decoding other frames.

To provide further detail, the following different types of reference frame buffer updates are observed: 1) refresh all slots of the reference frame buffer, 2) refresh none of slots of the reference frame buffer, 3) select and refresh one slot of the reference frame buffer, and 4) select and refresh more than one slot of the reference frame buffer. In the first case, no signaling is necessary and it can be inferred to refresh all of the slots based on the type of the current frame being decoded. For example, if the current frame is a key or GOLDEN frame or a SWITCH frame (further described below), then it can be inferred that all slots are to be refreshed (e.g., invalidated). That is, in scenarios necessitating a complete buffer refresh, the frame type (key/GOLDEN frame or SWITCH frame) serves as an implicit indicator, thereby obviating the need for explicit signaling.

In scenarios where none (the second case) or one (the third case) of the buffer slots are to be refreshed, the encoder employs a compact signaling technique using 3+1 bits. Specifically, the encoder signals a 3-bit variable, which can represent any integer from 0 to 7, to identify one of the eight possible buffer slots that may be refreshed. If the signaled value i is between 1 and 7 (i.e., i∈[1,7]), the decoder refreshes the corresponding i^{th} buffer slot directly. On the other hand, if the value i equals 0, an additional 1-bit flag j is utilized: if j equals 1, the 0^{th} buffer slot is refreshed; if j equals 0, none of the buffer slots are refreshed.

This signaling strategy effectively reduces the bit overhead required per frame from 8 bits (using the conventional bitmap approach) to an average of 3.125 bits (described below with respect to equation (1)), achieving significant bitrate savings especially in video-on-demand (VOD) and other similar use cases where the update frequency of multiple buffers is low. Moreover, this technique allows for precise control and flexibility in buffer management, facilitating optimal encoder performance with minimal communication overhead.

$$\frac{7}{8} \times 3 + \frac{1}{8} \times ( 3 + 1 ) = 3.125 \qquad ( 1 )$$

In equation (1), the

$$( \frac{7}{8} \times 3 )$$

part calculates the average number of bits used in most cases, where one of the buffers (from 1 to 7) is refreshed. Since there are eight buffer slots and seven of them (1 through 7) use a 3-bit signal to indicate which slot is being refreshed, the probability of any of these slots being refreshed is ⅞. Multiplying this by 3 bits gives the average bits used when these slots are selected. The

$$( \frac{1}{8} \times ( 3 + 1 ) )$$

part accounts for the scenario where either none of the buffer slots or the oth buffer slot is refreshed. The probability of this scenario occurring is ⅛, and it requires an additional 1 bit on top of the 3 bits (total 4 bits) to signal either no refresh or the refresh of the 0^{th} slot. This extra bit (making it 4 bits instead of 3) is necessary to distinguish between refreshing the 0^{th} buffer slot and not refreshing any slots at all.

Furthermore, in cases where multiple (e.g., more than one) buffer slots are to be updated, the conventional 8-bit (in the case that the reference frame buffer includes 8 slots) signaling mechanism can be used to ensure robustness and compatibility with scenarios requiring high error resilience or complex multi-frame referencing, as observed in applications such as WebRTC video conferencing and live streaming with temporal and spatial scalability.

A second technique, referred to herein as the pyramid-level technique, uses the level of a current frame within a multi-level (e.g., hierarchical or pyramid) coding structure to infer (e.g., determine, identify, select, etc.) which slots of the reference frame buffer are to be updated. According to the pyramid-level technique, a group of pictures is determined to be decoded using a multi-level coding structure. A pyramid level indicative of a level within the multi-level coding structure is decoded from a frame header of a current frame of the group of pictures. The current frame is decoded. A reference frame buffer is then updated based on the pyramid level.

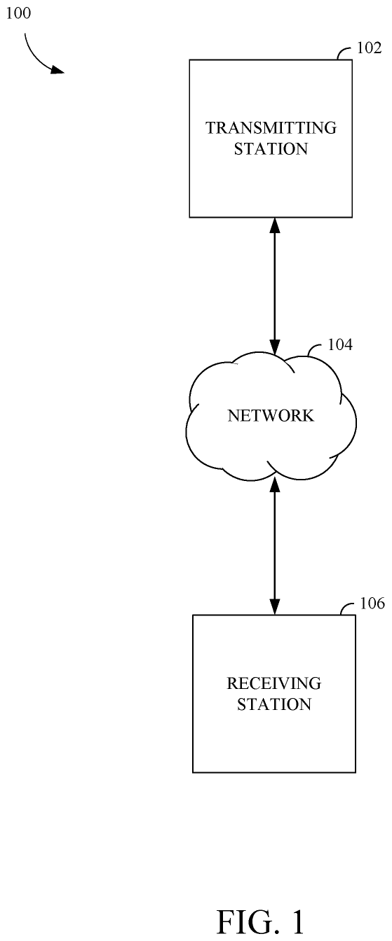

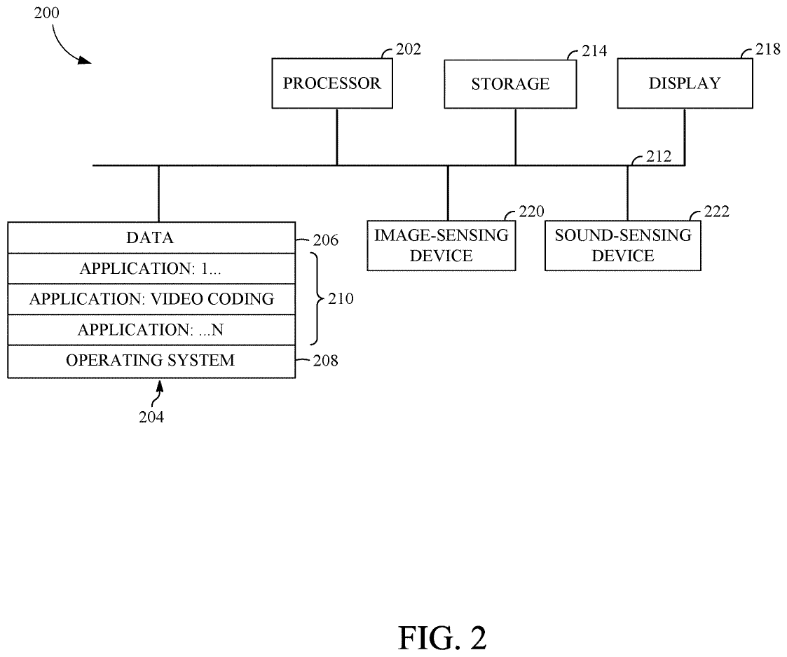

Further details of reference frame flag signaling are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

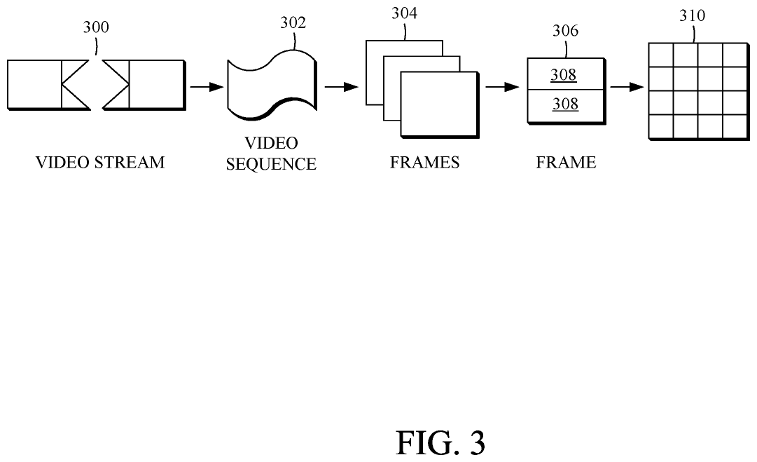

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

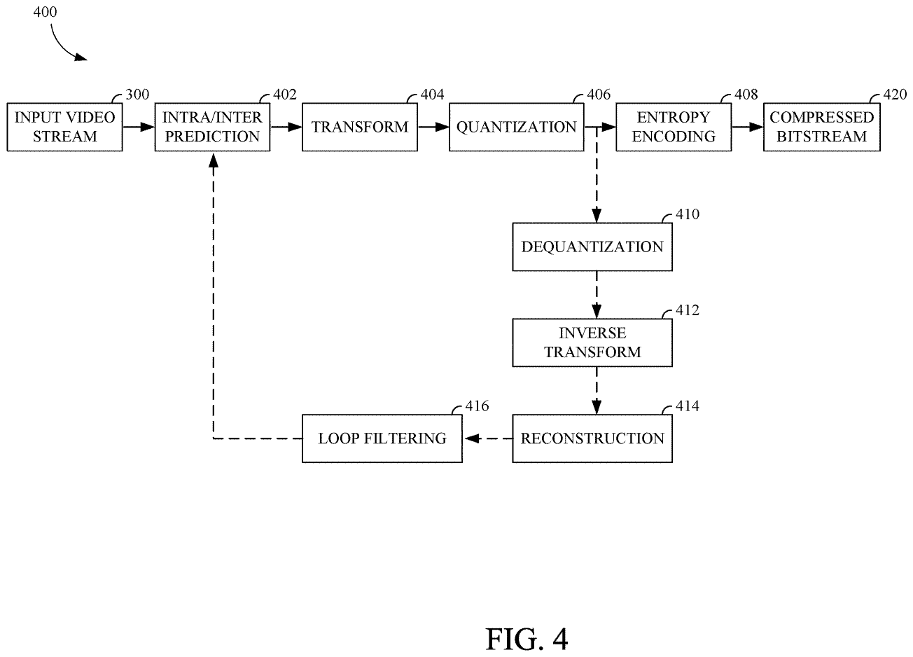

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

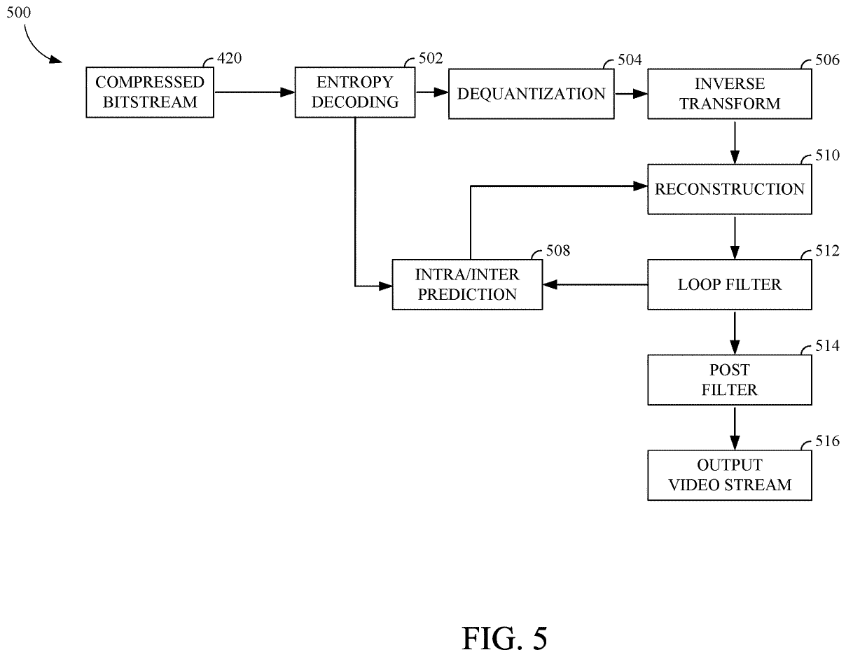

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

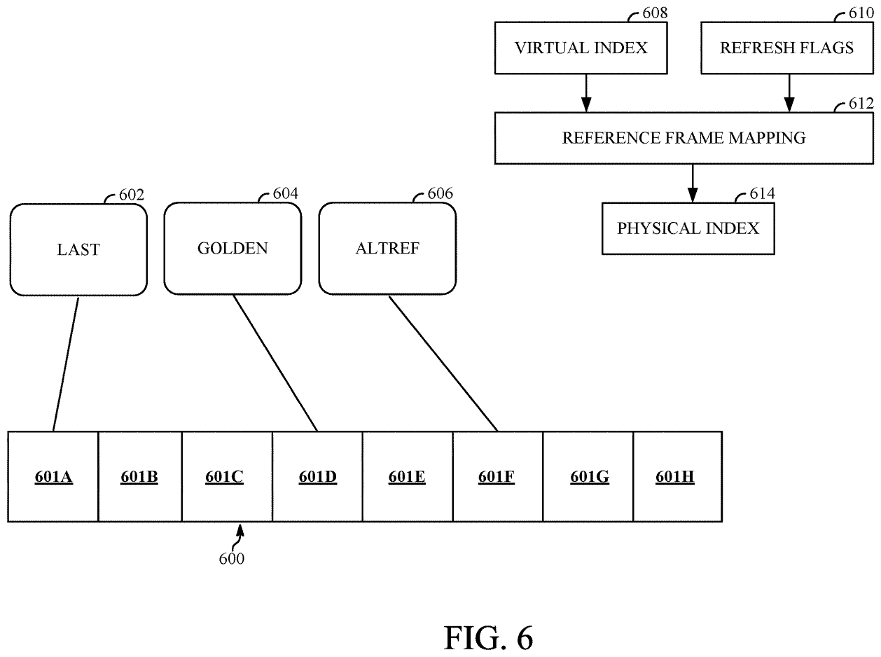

FIG. 6 is a block diagram of an example of a reference frame buffer 600. The reference frame buffer 600 stores reference frames used to encode or decode blocks of frames of a video sequence. The reference frame buffer 600 includes slots 601A-601H. A reference frame can be stored in one of the slots 601A-601H. Labels and/or roles may be associated with or used to describe different reference frames stored in the reference frame buffer. The reference frame buffer 600 is provided as an illustration and operation of a reference frame buffer and implementations according to this disclosure may not result in reference frames as described with respect to FIG. 6. FIG. 6 is used to describe one implementation of a reference frame buffer and a certain way of storing and associating roles and labels with the frames stored in the reference frame buffer 600. However, the disclosure herein is not limited to or by the description of FIG. 6 and other ways of organizing, storing, and referencing reference frames in the reference frame buffer are possible.

The reference frame buffer 600 includes a last frame LAST 602, a golden frame GOLDEN 604, and an alternative reference frame ALTREF 606. The frame header of a reference frame can include a virtual index 608 to a location within the reference frame buffer 600 at which the reference frame is stored. A reference frame mapping 612 can map the virtual index 608 of a reference frame to a physical index 614 of memory at which the reference frame is stored. Where two reference frames are the same frame, those reference frames can have the same physical index even if they have different virtual indexes. One or more refresh flags 610 can be used to remove one or more of the stored reference frames from the reference frame buffer 600, for example, to clear space in the reference frame buffer 600 for new reference frames, where there are no further blocks to encode or decode using the stored reference frames, or where a new golden frame is encoded or decoded.

The reference frames stored in the reference frame buffer 600 can be used to identify motion vectors for predicting blocks of frames to be encoded or decoded. Different reference frames may be used depending on the type of prediction used to predict a current block of a current frame. For example, in an inter-inter compound prediction, blocks of the current frame can be forward predicted using any combination of the last frame LAST 602, the golden frame GOLDEN 604, and the alternative reference frame ALTREF 606.

There may be a finite number of reference frames that can be stored within the reference frame buffer 600. As shown in FIG. 6, the reference frame buffer 600 can store up to eight reference frames. Each of the stored reference frames can be associated with a respective virtual index 608 of the reference frame buffer. Although three of the eight spaces in the reference frame buffer 600 are used by the last frame LAST 602, the golden frame GOLDEN 604, and the alternative reference frame ALTREF 606, five spaces remain available to store other reference frames.

In particular, one or more available spaces in the reference frame buffer 600 may be used to store additional alternative reference frames (e.g., ALTREF1, ALTREF2, EXTRA ALTREF, etc., wherein the original alternative reference frame ALTREF 606 could be referred to as ALTREF0). The alternative reference frame ALTREF 606 is a frame of a video sequence that is distant from a current frame in a display order, but is encoded or decoded earlier than it is displayed. For example, the alternative reference frame ALTREF 606 may be ten, twelve, or more (or fewer) frames after the current frame in a display order.

The additional alternative reference frames can be frames located nearer to the current frame in the display order. For example, a first additional alternative reference frame, ALTREF2, can be five or six frames after the current frame in the display order, whereas a second additional alternative reference frame, ALTREF3, can be three or four frames after the current frame in the display order. Being closer to the current frame in display order increases the likelihood of the features of a reference frame being more similar to those of the current frame. As such, one of the additional alternative reference frames can be stored in the reference frame buffer 600 as additional options usable for backward prediction.

Although the reference frame buffer 600 is shown as being able to store up to eight reference frames, other implementations of the reference frame buffer 600 may be able to store additional or fewer reference frames. Furthermore, the available spaces in the reference frame buffer 600 may be used to store frames other than additional alternative reference frames. For example, the available spaces may store a second last frame LAST2 and/or a third last frame LAST3 as additional forward prediction reference frames. In another example, a backward frame BWDREF may be stored as an additional backward prediction reference frame.

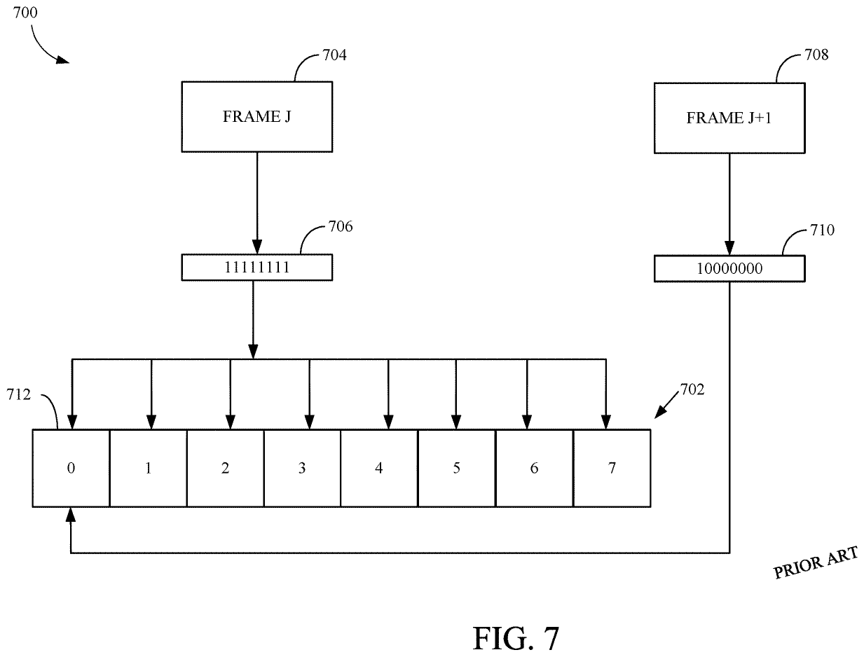

FIG. 7 is an illustration 700 of conventional signaling and a technique for updating a reference frame buffer. The illustration 700 includes a reference frame buffer 702, which can be the reference frame buffer 600 of FIG. 6. The reference frame buffer 702 is illustrated as including eight slots, numbered slot 0 to slot 7.

As mentioned above, the reference frame buffer 702 can be updated according to a bitmap that includes one bit (e.g., one flag) for each of the slots of the reference frame buffer 702. If a bit at location j of the bitmap is set (e.g., is equal to 1), then the reference frame included in the corresponding j^{th} slot of the reference frame buffer can no longer be used and/or may be overwritten by the current frame. To illustrate, if the reference frame buffer includes 8 slots, then the bitmap 01000011 results in the removal (e.g., invalidating or making unavailable) the reference frames in the second, seventh, and eighth slots (i.e., slots numbered 1, 6, and 7, respectively, in FIG. 7). The bitmap may be encoded/decoded in/from a compressed bitstream (such as described with respect to a bitmap 710) or may be inferred based on the frame type (such as described with respect to a bitmap 706).

After a frame 704, which for purposes of this illustration is assumed to be either a GOLDEN frame or a SWITCH frame, is reconstructed, such as described with respect to the reconstruction path of FIG. 4 or the loop filtering stage 512 of FIG. 5, the reference frame buffer 702 can be updated according to the bitmap 706. The bitmap 706 may not be included in the compressed bitstream but may be inferred based on the type of the frame 704. Based on the type of the frame 704 (e.g., either GOLDEN or SWITCH), all the bits of the bitmap 706 (i.e., the refresh frame flags) are assumed to be set.

A GOLDEN (or key) frame is as described above with respect to FIG. 6. A SWITCH frame is an inter frame that can be used as a point to switch between video sequences. Switch frames can be used to overwrite all the reference frames of the reference frame buffer 702 without forcing the use of intra coding, as in the case of a GOLDEN frame. SWITCH frames can be used to enable streaming use cases where videos can be encoded in small chunks (e.g., chunks of 1 second duration), each starting with a SWITCH frame. If the available bandwidth drops, a server (e.g., a streaming server) can start sending chunks from a lower bitrate encoding. SWITCH frames enable bitrate switch without the cost of a full GOLDEN frame.

As each of the bits of the bitmap 706 is set (e.g., is equal to 1), each of the slots of the reference frame buffer 702 are invalidated. Invalidating a slot can include that the reference frame stored therein can no longer be used as a reference frame to decode other frames and/or that slot is available for storing another frame to be used as a reference frame.

After a frame 708, which for purposes of this illustration is assumed to be neither a GOLDEN frame nor a SWITCH frame, is reconstructed, the reference frame buffer 702 can be updated according to the bitmap 710, which may be decoded from a compressed bitstream, such as the compressed bitstream 420 of FIG. 5. The bitmap 710 can be decoded from a header of the frame 708. As the reference frame buffer 702 includes eight slots, the bitmap 710 described with respect to FIG. 7 also includes eight bits. As the bit at the location 0^{th} of the bitmap 710 is set (e.g., is equal to 1), the corresponding slot 712 is invalidated.

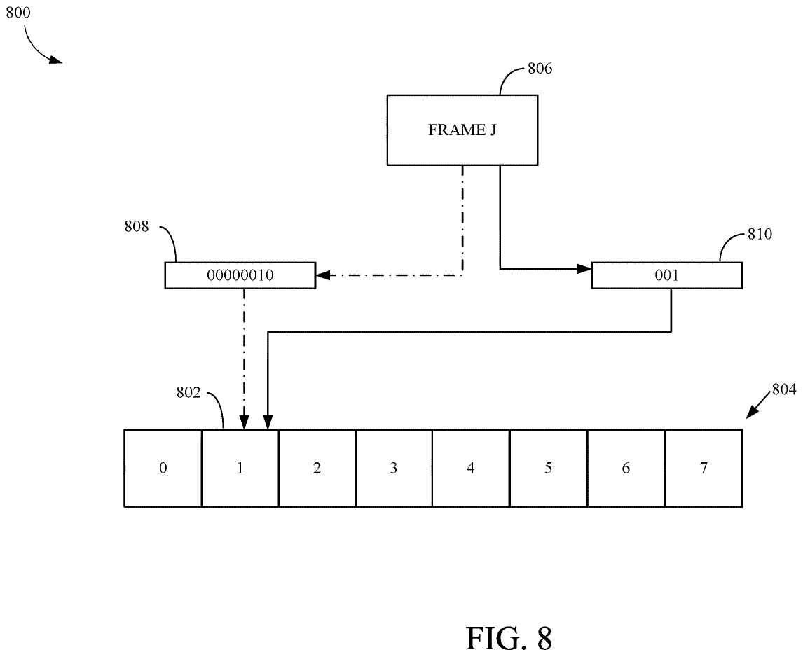

FIG. 8 is an illustration 800 of reference frame flag signaling according to the n-bit integer technique. If the frame buffer includes N slots, then instead of using a bitmap of N bits as described above with respect to FIG. 7, an integer variable that uses n-bits can be used instead, where n=ceiling (log₂[(N)] and where ceiling(·) represents the ceiling function, which rounds up to the nearest integer. For example, if N=8, then a 3-bit variable (3=ceiling(log₂(8))) can be used.

Assuming that a slot 802 of a reference frame buffer 804 is to be updated after a frame 806 is decoded, a bitmap 808 (having 8 bits) would have to be used according to the conventional technique described with respect to FIG. 7. Contrastingly, a variable 810 (having only 3 bits) would be used in the case of the n-bit integer technique. Thus, to update a particular slot of the reference frame buffer 804, Table I indicates the 8-bit bitmaps and the 3-bit variables that would be used. In Table I, a number prefixed by “Ox” indicates that the number is written in the hexadecimal notation and a number prefixed by “Ob” indicates that the number is written in the binary notation. The signaled n-bit variable may be named slot_to_refresh.

TABLE I

| Slot # to Update | 8-bit Bitmap | 3-bit variable |
|---|---|---|
| 0 | 0x01 (0b00000001) | 0b000 |
| 1 | 0x02 (0b00000010) | 0b001 |
| 2 | 0x02 (0b00000100) | 0b010 |
| 3 | 0x04 (0b00001000) | 0b011 |
| 4 | 0x10 (0b00010000) | 0b100 |
| 5 | 0x20 (0b00100000) | 0b101 |
| 6 | 0x40 (0b01000000) | 0b110 |
| 7 | 0x80 (0b10000000) | 0b111 |

As a general proposition, and as described above, four different types of reference frame buffer updates can be distinguished: a first type is the updating (e.g., invalidating) all of the slots of the reference frame buffer at once; a second type is the updating of none of slots of the reference frame buffer; a third type is updating only one slot of the reference frame buffer; and a fourth type is the selective updating of any selected combination of slots.

In the n-bit integer technique, for the first type, the refresh frame flag(s) can be inferred by the frame type, as described above. As such no signaling of the n-bit variable is required.

As described above, signaling of the second and the third type can be accomplished via a 3+1 bits (in the case that the reference frame buffer includes 8 slots). As such, using the n-bit variable signaling can result in bit savings without loss of functionality. As already mentioned, if the reference frame buffer includes eight slots, then a minimum of four bits per frame can be saved. A first variable, slot_to_refresh, may be signaled (e.g., decoded from the compressed bitstream) indicating the slot number of the slot of the frame buffer to be refreshed. An additional flag (update_first) is also signaled if slot_to_refresh is zero, as illustrated in Table II. If update_first is set to 1, then the 0^{th} slot of the reference frame buffer is updated. If update_first is set to 0, then none of slots of the reference frame buffers are refreshed. If slot_to_refresh is not equal to zero, then the compressed bitstream does not include, and the decoder does not decode, the variable update_first.

TABLE II

| | |
|---|---|
| slot_to_refresh | f(3) |
| if (slot_to_refresh == 0) | |
| update_first | f(1) |

As described above, an encoder determines, and encodes (implicitly or explicitly), in a compressed bitstream, which slots of the reference frame buffer are to be updated. A decoder decodes such information and updates the reference frame buffer accordingly. That is, explicit instructions may be conveyed from the encoder to the decoder as to which slots are to be updated when less than all, if any, of the slots are to be refreshed. As mentioned, if a current frame being decoded is a GOLDEN or SWITCH frame, then the decoder can infer that all of the slots are to be refreshed.

In the case of the fourth type of reference frame buffer updates (e.g., more than one but less than all of the slots are refreshed or invalidated), which of the slots are to be updated can be signaled using the conventional bitmap (e.g., an 8-bit bitmap). The bitmap mechanism is useful in applications where more than one slot are to be refreshed, such as in the case of error resilient mode; video conferencing (such as using WebRTC); or certain streaming applications especially those with temporal and spatial scalability where multiple reference frames may be updated to ensure better playback performance.

A sequence-level flag can be decoded from the compressed bitstream indicating which frame buffer signaling is used. That is, the sequence flag can indicate whether the conventional bitmap mechanism or the fewer bits mechanism (i.e., a non-bitmap mechanism), as described herein, is used for the sequence (e.g., the whole of the video sequence).

In other implementations according to this disclosure (i.e., the pyramid-level technique), no specific refresh frame flags (i.e., bitmaps) or integer values (i.e., n-bit variables) are included in the bitstream. Instead, the encoder may transmit a pyramid level of a current frame being decoded. Subsequent to decoding (e.g., reconstructing) the current frame, the reference frame buffer can be updated based on the pyramid level of the current frame.

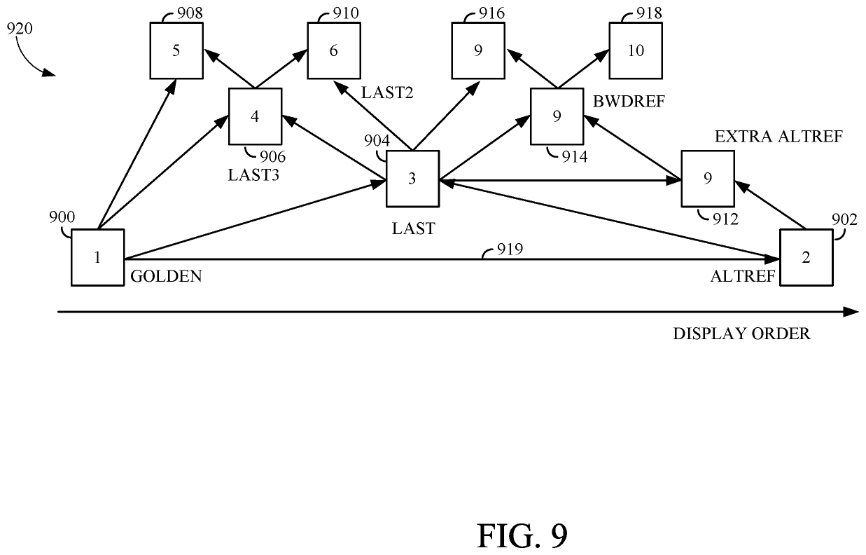

Pyramid level refers to the level of the current frame in a multi-layer (hierarchical or pyramid) coding structure. FIG. 9 is a diagram of an example of a multi-layer coding structure 920. The multi-layer coding structure 920 shows a coding structure of a group of frames, also known as a group of pictures (GOP), of length 10 (i.e., the group of frames includes 10 frames): frames 900-918. FIG. 9 is used to describe one implementation and the concept of multi-layer coding structures and a particular way of using the reference frames stored in the reference frame buffer 600 of FIG. 6. However, the disclosure is not limited to or by the description of FIG. 9 and other ways of implementing a multi-layer coding structure and referencing (e.g., using) reference frames in the reference frame buffer are possible.

A codec may partition (e.g., group) a video sequence into GOPs. The terms group of pictures, group of frames, and golden-frame group (GF group) may be used interchangeably. A GOP is a successive group of frames of the video sequence. The GOPs are non-overlapping groups of frames. To illustrate, and without loss of generality, a video sequence having 150 frames may be partitioned into 10 GOPs each containing 15 frames, 15 GOPs each containing 10 frames, or some other division. Temporal dependencies in one GOP do not typically propagate to another GOP.

The GOPs of the video sequence need not have the same number of frames. The number of frames of a GOP is referred to as the length of the GOP. For example, a video sequence can be partitioned into GOPs where a GOP can have a length between 4 and 16 frames. The number of frames forming each group of frames can vary according to the video spatial/temporal characteristics and other encoded configurations, such as the key frame interval selected for random access or error resilience, for example. The number of frames forming each group may be determined by a first pass of a two- or a multi-pass encoder, such as the encoder 400 of FIG. 4.

A coding structure of a GOP determines (or dictates) which frames of the GOP are coded before which other frames and which frames can be used as (e.g., are available for use as) reference frames for other frames. Regardless of the coding order of the frames of the GOP, the first frame of the GOP is displayed first, the second frame of the GOP is displayed next, and so on.

As mentioned, the frames of a GOP may be coded in a coding order that may be different from the display order of the frames. For example, an encoder may receive the frames in the display order, determine a coding order (or a coding structure), and encode the frames of the GOP accordingly. For example, a decoder may receive the frames (e.g., in an encoded bitstream) in the coding order, decode the frames in the coding order, and display the frames in the display order.

As frames are coded (i.e., encoded by an encoder or decoded by a decoder), they may be added to a reference frame buffer and assigned different roles (e.g., LAST, GOLDEN, ALTREF, LAST2, LAST3, BWDREF, etc.) for the coding of a subsequent frame. That is, some frames that are coded first may be stored in the reference frame buffer and used as reference frames for the coding (using inter-prediction) of other frames. For example, the first frame of a GOP may be coded first and assigned as a GOLDEN frame, and the last frame within a GOP may be coded second, assigned as an alternative reference (i.e., ALTREF) for the coding of all the other frames.

To illustrate the concept of multi-level coding structures, and without loss of generality or without any limitations as to the present disclosure, a multi-layer coding structure is described below with respect to FIG. 9. It is noted that, when referring to an encoder, coding means encoding; and when referring to a decoder, coding means decoding.

The frames of a GOP may be coded independently of the frames of other GOP groups. In the general case, the first frame of the GOP may be coded using intra prediction and all other frames of the GOP are coded using other frames of the GOP as reference fames. In some cases, the first frame of the GOP can be coded using frames of a previous GOP. In some cases, the last frame of the GOP can be coded using frames of a previous GOP. In some cases, the first and the last frame of a GOP may be coded using frames of prior GOPs.

In an example, three reference frames may be available to encode or decode blocks of other frames of the video sequence. The first reference frame may be an intra-predicted frame, which may be referred to as a key frame or a golden frame. In some coding structures, the second reference frame may be a most recently encoded or decoded frame. The most recently encoded or decoded frame may be referred to as the LAST frame. The third reference frame may be an alternative reference frame that is encoded or decoded before most other frames, but which is displayed after most frames in an output bitstream. The alternative reference frame may be referred to as the ALTREF frame. The efficacy of a reference frame when used to encode or decode a block can be measured based on the resulting signal-to-noise ratio.

An encoder, such as the encoder 400 of FIG. 4, can encode a GOP according to the multi-layer coding structure 920. A decoder, such as the decoder 500 of FIG. 5, can decode the group of frames using the multi-layer coding structure 920. The decoder can receive an encoded bitstream, such as the compressed bitstream 420 of FIG. 5. In the encoded bitstream, the frames of the group of frames can be ordered (e.g., sequenced, stored, etc.) in the coding order of the multi-layer coding structure 920. The decoder can decode the frames in the multi-layer coding structure 920 and display them in their display order. The encoded bitstream can include syntax elements that can be used by the decoder to determine the display order.

The numbered boxes of FIG. 9 indicate the coding order of the group of frames. As such, the coding order is given by the frame order: 900, 902, 904, 906, 908, 910, 912, 914, 916, and 918. The display order of the frames of the group of frames in indicated by the left-to-right order of the frames. As such, the display order is given by the frame order: 900, 908, 906, 910, 904, 916, 914, 918, 912, and 902. That is, for example, the second frame in the display order (i.e., the frame 908) is the 5^{th} frame to be coded; the last frame of the group of frames (i.e., the frame 902) is the second frame to be coded.

In FIG. 9, the first layer includes the frames 900 and 902, the second layer includes the frames 904 and 912, the third layer includes the frames 906 and 914, and the fourth layer includes the frames 908, 910, 916, and 918. The frames of a layer do not necessarily correspond to the coding order. For example, while the frame 912 (corresponding to coding order 7) is in the second layer, frame 906 (corresponding to coding order 4) of the third layer and frame 908 (corresponding to coding order 5) of the fourth layer are coded before the frame 912.

In a multi-layer coding structure, such as the multi-layer coding structure 920, the frames within a GOP may be coded out of their display order and the coded frames can be used as backward references for frames in different (i.e., higher) layers.

The coding structure of FIG. 9 is said to be a multi-layer coding structure because frames of a layer are coded using, as reference frames, only coded frames of lower layers and coded frames of the same layer. That is, at least some frames of lower layers and frames of the same layer of a current frame (i.e., a frame being encoded) can be used as reference frames for the current frame. A coded frame of the same layer as the current frame is a frame of the same layer as the current frame and is coded before the current frame. For example, the frame 912 (coding order 7) can be coded using frames of the first layer (i.e., the frames 900 and 902) and coded frames of the same layer (i.e., the frame 904). As another example, the frame 910 (coding order 6) can be coded using already coded frames of the first layer (i.e., the frames 900 and 902), already coded frames of the second layer (i.e., the frame 904), already coded frames of the third layer (i.e., the frame 906), and already coded frames of the same layer (i.e., the frame 908). Which frames are actually used to code a frame depends on the roles assigned to the frames in the reference frame buffer.

The arrows in FIG. 9 illustrate partial examples of which frames can be used, as reference frames, for coding a frame. For example, as indicated by the arrows, the frame 900 can be used to code the frame 902, the frames 900 and 902 can be used to code the frame 904, and so on. However, as already mentioned, for the sake of reducing clutter, only a subset of the possible arrows is displayed. For example, as indicated above, the frames 900 and 902 can be used for coding any other frame of the group of frames; however, no arrows are illustrated, for example, between the frames 900 and/or 902 and the frames 910, 916, 918, etc.

In an implementation, the number of layers and the coding order of the frames of the group of frames can be selected by an encoder based on the length of the group of frames. For example, if the group of frames includes 10 frames, then the multi-layer coding structure of FIG. 9 can be used. In another example, if the group of frames includes nine (9) frames, then the coding order can be frames 1, 9, 8, 7, 6, 5, 4, 3, and 2. That is, for example, the 3^{rd} frame in the display order is the coded 8th in the coding order. A first layer can include the 1^{st} and 9^{th} frames in the display order, a second layer can include the 5^{th} frame in the display order, a third layer can include the 3^{rd} and 7^{th} frames in the display order, and a fourth layer can include the 2^{nd}, 4^{th}, 6^{th}, and 8^{th} frames in the display order.

As mentioned above, the coding order for each group of frames can differ from the display order. This allows a frame located after a current frame in the video sequence to be used as a reference frame for encoding the current frame. A decoder, such as the decoder 500, may share a common group coding structure with an encoder, such as the encoder 400. The group coding structure assigns different roles that respective frames within the group may play in the reference frame buffer (e.g., a last frame, an alternative reference frame, etc.) and defines or indicates the coding order for the frames within a group.

In a multi-layer coding structure, the first frame and last frame (in display order) are coded first. As such, the frame 900 (the first in display order) is coded first and the frame 902 (the last in display order) is coded next. The first frame of the group of frames can be referred as (i.e., has the role of) the GOLDEN frame such as described with respect to the golden frame GOLDEN 604 of FIG. 6. The last frame in the display order (e.g., the frame 902) can be referred to as (i.e., has the role of) the ALTREF frame, as described with respect to the alternative reference frame ALTREF 606 of FIG. 6.

In coding blocks of each of the frames 904-918, the frame 900 (as the golden frame) is available as a forward prediction frame and the frame 902 (as the alternative reference frame) is available as a backward reference frame. Further, the reference frame buffer, such as the reference frame buffer 600, is updated after coding each frame so as to update the identification of the reference frame, also called a last frame (e.g., LAST), which is available as a forward prediction frame in a similar manner as the frame 900. For example, when blocks of the frame 906 are being predicted (e.g., at the intra/inter prediction stage 402), the frame 908 can be designated the last frame (LAST), such as the last frame LAST 602 in the reference frame buffer 600. When blocks of the frame 908 are being predicted, the frame 906 is designated the last frame, replacing the frame 904 as the last frame in the reference frame buffer. This process continues for the prediction of the remaining frames of the group in the encoding order.

The first frame can be encoded using inter- or intra-prediction. In the case of inter-prediction, the first frame can be encoded using frames of a previous GOP. The last frame can be encoded using intra- or inter-prediction. In the case of inter-prediction, the last frame can be encoded using the first frame (e.g., the frame 900) as indicated by the arrow 919. In some implementations, the last frame can be encoded using frames of a previous GOP. All other frames (i.e., the frames 904-918) of the group of frames are encoded using encoded frames of the group of frames as described above.

The GOLDEN frame (i.e., the frame 900) can be used as a forward reference and the ALTREF (i.e., the frame 902) can be used as a backward reference for coding the frames 904-918. As every other frame of the group of frames (i.e., the frames 904-918) has available at least one past frame (e.g., the frame 900) and at least one future frame (e.g., the frame 902), it is possible to code a frame (i.e., to code at least some blocks of the frame) using one reference or two references (e.g., inter-inter compound prediction).

In a multi-layer coding structure, some of the layers can be assigned roles. For example, the second layer (i.e., the layer that includes the frames 904 and 912) can be referred to as the EXTRA ALTREF layer, and the third layer (i.e., the layer that includes the frames 906 and 914) can be referred to as the BWDREF layer. The frames of the EXTRA ALTREF layer can be used as additional alternative prediction reference frames. The frames of the BWDREF layer can be used as additional backward prediction reference frames.

In FIG. 9, the frames 900 and 902 are at a zeroth level of the pyramid; the frames 904 and 912 at a first level of the pyramid; the frames 906 and 914 are a second level of the pyramid; and frames 908, 910, 916, and 918 are at a third level of the pyramid.

In the pyramid-level technique, the pyramid level of a frame may be encoded in a header of the frame. As the decoder cannot determine the pyramid level of a frame, the encoder encodes such information for the decoder to decode and use. The pyramid level may be encoded using a number that is based on the maximum possible coding structure depth.

In an example, the maximum possible coding structure depth may be 8 levels. As such, 3 bits would be required to convey the pyramid level of a frame. In another example, the maximum possible coding structure depth can be based on the number of frames in the GOP. For example, a maximum of four levels may be possible if the number of frames in the GOP is less than a predefined number. For example, if the number of frames in a GOP is between a first number of frames (e.g., 8) and a second number of frames (e.g., 15), then the maximum possible coding structure depth may be four. As such, two bits would be required to convey the pyramid level of a frame.

As further described herein, after decoding a frame, the decoder can use the pyramid level of the frame to determine how the reference frame buffer is to be updated. That is, the decoder can use the pyramid level of the frame to identify the slots of the reference frame buffer to update and to update those slots. In this case, the encoder and the decoder use the same logic for updating the reference frame buffer based on the pyramid level. Different reference frame buffer update strategies (e.g., algorithms) may be implemented and the disclosure herein is not limited to or by any particular strategy as long as both the encoder and the decoder implement the same strategy.

In an example, the codec may determine, for a given frame just decoded, which reference frames to retain and/or discard. The codec can keep track of the oldest reference frame that is at the same level as the current frame, the oldest reference frame that is at level one, and the frame with the oldest display order. The following ordered steps are applied to identify a frame to be discarded (i.e., the slot of the reference frame buffer to invalidate). The oldest reference frame in the reference frame buffer that is at the same level as the current frame is identified. In this context, the “oldest reference frame in the reference frame buffer” refers to the frame that is placed earliest in time in the reference frame buffer from amongst the reference frames currently stored in the reference frame buffer. If such a frame exists in the reference frame buffer, it is discarded. If no such frame exists in the reference frame buffer, then the oldest reference frame that is at level one is discarded if the current frame is also at level one and there are more than two reference frames at level one in the reference frame buffer. If no such frame exists, the frame with the oldest display order is identified and discarded. If no such frame exists in the reference frame buffer, then the oldest reference frame at level one that is in the reference frame buffer is discarded.

With respect to the reference frame buffer update types described above, the first type can be handled similarly to the n-bit integer technique (i.e., based on frame type). With respect to the second type, and as contrasted with the n-bit integer technique, the pyramid level can be used to update multiple slots of the reference frame buffer. With respect to the third type, the pyramid level can also be used to determine not to update any slots of the reference frame buffer. As such, and as compared to the n-bit integer technique, the pyramid-level technique enables the refreshing of multiple slots of reference frame buffer and not refreshing any slots.

In an example, and to enable error resilience, which may always require the conveyance (e.g., transmission in the compressed bitstream) of refresh frame flags, when error resilient mode is enabled, the n-bit integer technique is used for reference frame buffer updates. As such, if the decoder decodes data (e.g., flags or syntax elements) indicating that error resilient mode is enabled, then the decoder updates the reference frame buffer according to the n-bit integer technique.

In an example, a sequence level flag (e.g., signal_refresh_frame_flags) can be used to indicate whether the n-bit variable approach or the pyramid level approach is to be used. The signal_refresh_frame_flags flag can be signaled at the sequence header and consumes 1 bit. A value of “1” can indicate that the pyramid level approach is to be used; and a value of “0” can indicate that the n-bit variable approach is used. In another example, a sequence level flag can be used to indicate whether the n-bit variable approach or the conventional bitmap approach is to be used.

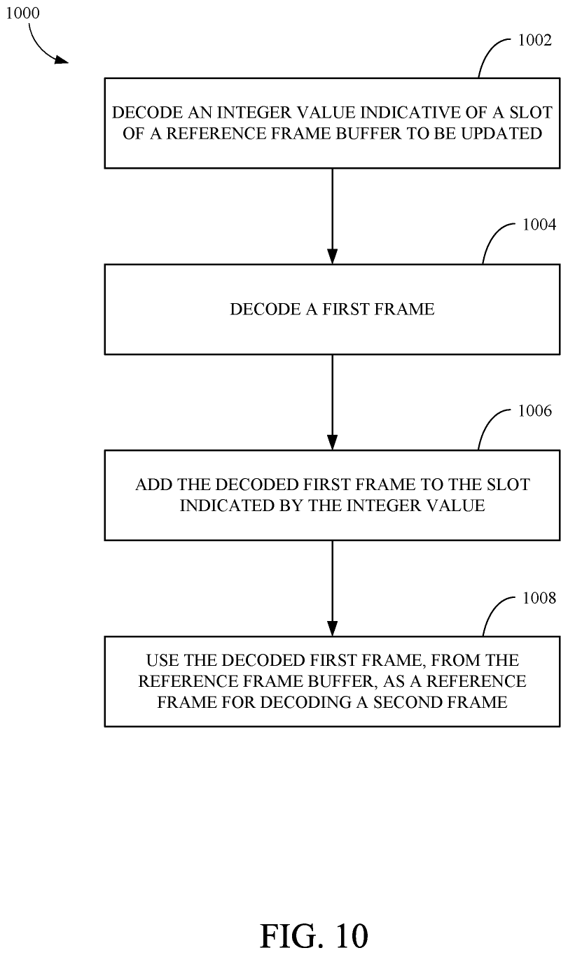

FIG. 10 is a flowchart diagram of a technique 1000 for updating a reference frame buffer. The technique 1000 updates the reference frame buffer according to the n-bit integer technique. The technique 1000 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1000. The technique 1000 may be implemented in whole or in part in after the loop filtering stage 416 of the encoder 400 of FIG. 4 and/or after the loop filtering stage 512 of the decoder 500 of FIG. 5. The technique 1000 can be implemented using specialized hardware or firmware. Multiple processors, memories, or both, may be used.

At 1002, an integer value indicative of a slot of a reference frame buffer to be updated is decoded from a compressed bitstream, which can be the compressed bitstream 420 of FIG. 5. The reference frame buffer can be the reference frame buffer 600 of FIG. 6 or the reference frame buffer 804 of FIG. 8. The integer value can be decoded from a header of the first frame. The reference frame buffer may include N slots and the integer value can be represented by ceiling(log₂(N)) number bits, wherein ceiling( ) is a function that rounds up to a nearest integer.

At 1004, the first frame is decoded. That the first frame is decoded includes that the first frame has been reconstructed and filtered by the loop filtering stage. At 1006, the decoded first frame is added to the slot indicated by the integer value. More generally, the reference frame buffer is updated based on the integer value, which may or may not include that the decoded first frame is added to the slot indicated by the integer value. Updating the reference frame buffer based on the integer value can at least include invalidating (e.g., making unavailable) a reference frame stored in the reference frame buffer at the slot having a number equal to the integer value. In an example, the first frame may be immediately output (e.g., displayed) and, as such may not be added to the reference frame buffer. At 1008, the decoded first frame stored in the reference frame buffer can be used as a reference frame for decoding a second frame.

In an example, the technique 1000 can include decoding, from the compressed bitstream, another integer value indicative of either refreshing a predetermined slot of the reference buffer or refreshing no slot of the reference frame buffer. The another integer value can be decoded in the process of decoding a second frame. For example, the another integer value can be decoded from a header of the second frame. The another integer value can be the value 0. As described above, when the value 0 is decoded, another flag is decoded to indicate whether the predetermined slot (e.g., the 0^{th} slot) is to be updated or whether no slots are to be refreshed.

As such, the technique 1000 decodes a flag indicating whether to refresh the predetermined slot of the reference buffer or to refresh no slot of the reference frame buffer. If the flag indicates to refresh the predetermined slot, then the technique 1000 may in response add the decoded second frame to the predetermined slot. In another example, the technique 1000 may simply mark the predetermined slot as being available or, equivalently, that any reference frame contained therein is not to be used as a reference frame.

In an example, the technique 1000 can include decoding, from the compressed bitstream, a frame type of a third frame. The frame type can indicate that all slots of the reference frame buffer are to be refreshed. For example, the frame type of the third frame can indicate that the third frame is a GOLDEN or a SWITCH frame. As such, the technique 1000 determines to refresh all slots of the frame buffer based on the frame type.

In an example, the technique 1000 can include decoding, from the compressed bitstream, a flag indicating that no slots of the reference frame buffer are to be updated after a fourth frame is decoded. The flag can be the flag update_none, described herein. After the fourth frame is decoded, the technique 1000 omits updating (i.e., does not update) the reference frame buffer.

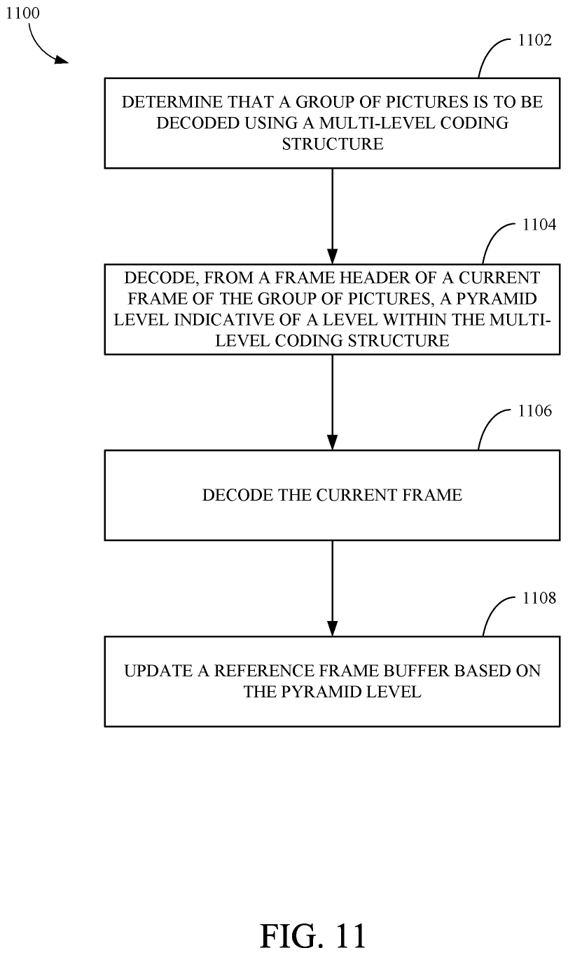

FIG. 11 is a flowchart diagram of another technique 1100 for updating a reference frame buffer. The technique 1100 updates the reference frame buffer according to the pyramid-level technique. The technique 1100 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1000. The technique 1100 may be implemented in whole or in part in after the loop filtering stage 416 of the encoder 400 of FIG. 4 and/or after the loop filtering stage 512 of the decoder 500 of FIG. 5. The technique 1100 can be implemented using specialized hardware or firmware. Multiple processors, memories, or both, may be used.

At 1102, it is determined that a group of pictures is to be decoded using a multi-level coding structure. In an example, a flag or a syntax element decoded from the compressed bitstream may indicate that the group of pictures is to be decoded using the multi-level coding structure. Other ways of determining that the group of pictures is to be decoded using a multi-level coding structure are possible. In an example, the pyramid level can be decoded as a three-bit integer number.

At 1104, a pyramid level indicative of a level within the multi-level coding structure is decoded from a frame header of a current frame of the group of pictures. At 1106, the current is decoded. At 1108, the reference frame buffer is updated based on the pyramid level. In an example, a flag indicating that the reference frame buffer is to be updated based on the pyramid level may be decoded from the compressed bitstream.

For simplicity of explanation, the techniques described herein, such as the techniques 1000 and 1100 of FIGS. 10 and 11, respectively, are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a non-transitory computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method, comprising:
decoding, from a compressed bitstream, an integer value indicative of a slot of a reference frame buffer to be updated;
decoding a first frame;
adding the decoded first frame to the slot indicated by the integer value; and
using the decoded first frame, from the reference frame buffer, as a reference frame for decoding a second frame.

2. The method of claim 1, further comprising:
decoding, from the compressed bitstream, another integer value indicative of either refreshing a predetermined slot of the reference frame buffer or refreshing no slot of the reference frame buffer; and
decoding, from the compressed bitstream, a flag indicating whether to refresh the predetermined slot of the reference frame buffer or to refresh no slots of the reference frame buffer.

3. The method of claim 2, further comprising:
determining that the flag indicates to refresh the predetermined slot; and
in response to the flag indicating to refresh the predetermined slot, adding a decoded second frame to the predetermined slot.

4. The method of claim 1, wherein the reference frame buffer includes N slots, and wherein the integer value is represented by ceiling(log₂(N)) number bits, wherein ceiling( ) is a function that rounds up to a nearest integer.

5. The method of claim 1, wherein the integer value is decoded from a header of the first frame.

6. The method of claim 1, further comprising:
decoding, from the compressed bitstream, a frame type of a third frame, wherein the frame type indicates that all slots of the reference frame buffer are to be refreshed; and
determining to refresh all slots of the frame buffer based on the frame type.

7. The method of claim 1, further comprising:
decoding, from the compressed bitstream, a flag indicating that no slots of the reference frame buffer are to be updated after a fourth frame is decoded;
decoding the fourth frame; and
omitting updating the reference frame buffer subsequent to decoding the fourth frame.

8.-14. (canceled)

15. A device, comprising a processor configured to:
decode, from a compressed bitstream, an integer value indicative of a slot of a reference frame buffer to be updated;
decode a first frame;
add the decoded first frame to the slot indicated by the integer value; and
use the decoded first frame, from the reference frame buffer, as a reference frame for decoding a second frame.

16. The device of claim 15, wherein the processor is further configured to:
decode, from the compressed bitstream, another integer value indicative of either refreshing a predetermined slot of the reference frame buffer or refreshing no slot of the reference frame buffer; and
decode, from the compressed bitstream, a flag indicating whether to refresh the predetermined slot of the reference frame buffer or to refresh no slots of the reference frame buffer.

17. The device of claim 16, wherein the processor is further configured to:
determine that the flag indicates to refresh the predetermined slot; and
in response to the flag indicating to refresh the predetermined slot, add a decoded second frame to the predetermined slot.

18. The device of claim 15, wherein the reference frame buffer includes N slots, and wherein the integer value is represented by ceiling(log₂(N)) number of bits, wherein ceiling( ) is a function that rounds up to a nearest integer.

19. The device of claim 15, wherein the integer value is decoded from a header of the first frame.

20. The device of claim 15, wherein the processor is further configured to:
decode, from the compressed bitstream, a frame type of a third frame, wherein the frame type indicates that all slots of the reference frame buffer are to be refreshed; and
determine to refresh all slots of the frame buffer based on the frame type.

21. The device of claim 15, wherein the processor is further configured to:
decode, from the compressed bitstream, a flag indicating that no slots of the reference frame buffer are to be updated after a fourth frame is decoded;
decode the fourth frame; and
omit updating the reference frame buffer subsequent to decoding the fourth frame.

22. A non-transitory computer-readable storage medium having stored thereon a compressed bitstream configured for decoding by operations that:
decode, from the compressed bitstream, an integer value indicative of a slot of a reference frame buffer to be updated;
decode a first frame;
add the decoded first frame to the slot indicated by the integer value; and
use the decoded first frame, from the reference frame buffer, as a reference frame for decoding a second frame.

23. The non-transitory computer-readable storage medium of claim 22, wherein the compressed bitstream is further configured for decoding by operations that:
decode, from the compressed bitstream, another integer value indicative of either refreshing a predetermined slot of the reference frame buffer or refreshing no slot of the reference frame buffer; and
decode, from the compressed bitstream, a flag indicating whether to refresh the predetermined slot of the reference frame buffer or to refresh no slots of the reference frame buffer.

24. The non-transitory computer-readable storage medium of claim 23, wherein the compressed bitstream is further configured for decoding by operations that:
determine that the flag indicates to refresh the predetermined slot; and
in response to the flag indicating to refresh the predetermined slot, add a decoded second frame to the predetermined slot.

25. The non-transitory computer-readable storage medium of claim 22, wherein the reference frame buffer includes N slots, and wherein the integer value within the compressed bitstream is represented by ceiling(log₂(N)) number of bits, wherein ceiling( ) is a function that rounds up to a nearest integer.

26. The non-transitory computer-readable storage medium of claim 22, wherein the integer value is decoded from a header of the first frame within the compressed bitstream.

27. The non-transitory computer-readable storage medium of claim 22, wherein the compressed bitstream is further configured for decoding by operations that:
decode, from the compressed bitstream, a frame type of a third frame, wherein the frame type indicates that all slots of the reference frame buffer are to be refreshed; and
determine to refresh all slots of the frame buffer based on the frame type.
